(19) United States
(12) Patent Application Publication
(10) Pub. No.: US 2007/0165159 A1
(43) Pub. Date: Jul. 19, 2007

(54) Driver for liquid-filled lens generating high-voltage drive signal

(76) Inventors: Hyo-Chung Lee, Yongin (KR); Sang-Hyun Han, Seoul (KR)

Correspondence Address: SHERR & NOURSE, PLLC, 620 HERNDON PARKWAY, SUITE 200, HERNDON, VA, 20170, US

(21) Appl. No.: 10/595,886

(22) PCT Filed: Nov. 26, 2004
(86) PCT No.: PCT/KR04/03076

§ 371 Date: May 18, 2006

(30) Foreign Application Priority Data
Nov. 27, 2003 (KR) 10-2003-0085041

(51) Int. Cl. G02F 1/1335

(52) U.S. Cl. 349/113

(57) ABSTRACT

A liquid-filled lens driver is disclosed. The liquid-filled lens includes an input/output interface unit, a system clock generation unit, a high voltage generation unit, a reference/bias voltage generation unit, a drive signal generation unit and a control unit. The input/output interface unit exchanges the lens driver control signal and the status information of the liquid-filled lens with the image signal processor. The high voltage generation unit generates high voltage using low voltage of a battery of a mobile information terminal. The voltage generation unit provides reference voltage and bias voltage for operating the liquid-filled lens driver. The drive signal generation unit generates a final drive signal for the liquid-filled lens. Data supplied from the esp@cenet database—Worldwide

### TECHNICAL FIELD

The present invention relates, in general, to a liquid-filled lens driver and an integrated chip therefor, which generate a high voltage drive signal using a low voltage source and, further, generate a drive signal in differential form, thus increasing the root mean square voltage between two electrodes of the liquid-filled lens that is applied by the high voltage drive signal that drives the liquid-filled lens.

### BACKGROUND ART

Currently, the function of a digital camera is essentially applied not only to a digital camera itself but also to a mobile information terminal, such as a mobile phone or a Personal Digital Assistant (PDA). However, such a mobile information terminal is small, so that only the basic function of a digital camera can be implemented therein.

That is, due to the size of a lens and the physical dimensions of a mechanical lens driving device, there is difficulty implementing advanced functions, such as auto focusing auto zooming and auto macro functions.

That is, in order to implement the above-described advanced functions, various types of lenses, such as a close-up lens, a normal lens, a telephoto lens and a zoom lens, should be provided a lens should be selectively used according to purpose, and the optical characteristics (focal distance) of a lens should be changed and a drive unit, such as a motor or a piezoelectric element, should be provided so as to implement an auto focusing function. Accordingly, it is difficult to implement a lens having advanced functions in a small-sized mobile information terminal.

Contrary to the conventional glass or plastic lens that must be provided with the above-described separate drive unit, the lens proposed by U.S. Pat. No. 5,774,273 entitled ‘Variable geometry liquid-filled lens and apparatus and method fir controlling the energy distribution of a light beam’ is made of liquid material, so that the curvature of the surface of the lens varies according to the amplitude of applied voltage and the waveform of a signal. Using the characteristics of the lens, advanced functions, such as auto focusing, auto zooming and auto macro functions, can be implemented using a single lens within the narrow internal space of a mobile information terminal.

A liquid-filled lens is an optical lens that can be employed as a lens of a mobile phone, a PDA or a regular digital camera. The liquid-filled lens is differentiated from a general lens in that the liquid-filled lens is made of special liquid material other than glass or plastic. In particular, the liquid-filled lens is characterized in that the lens is composed of two liquid surfaces having different characteristics, so that the refractive index of light passing through the lens varies according to voltage applied to the lens.

Contrary to existing lens sets using mechanical devices to implement focusing and zooming functions, the focusing and zooming functions can be implemented using a circuit fir controlling voltage based on the characteristics of the liquid-filled lens, so that lens, which is smaller, less expensive and more convenient than the conventional lenses, can be implemented.

That is, to increase the efficiency of voltage (drive voltage) for driving the liquid-filled lens, voltage of a specific form must be applied between the two input terminals of the liquid-filled lens. However, it is very difficult to implement a driver that generates a high voltage capable of driving the liquid-filled lens, in applications, such as a mobile phone, a PDA and a digital camera, which have a small internal space.

### DISCLOSURE OF INVENTION

### Technical Problem

Accordingly, the present invention has been made keeping in mind the above problems occurring in the prior art. An object of the present invention is to provide a liquid-filled lens driver that includes a voltage conversion circuit, a drive signal generation circuit, a high voltage driver and an external interface-related circuit that are specially designed to construct an optimized circuit for driving a liquid-filled lens, and an integrated chip therefor.

Another object of the present invention is to provide a means for ensuring the stability of a liquid-filled lens driver by detecting overcurrent or excessive voltage when the overcurrent or excessive voltage occurs in the liquid-filled lens driver and performing appropriate control.

### Technical Solution

According to an aspect of the present invention for achieving the objects, there is provided a liquid-filled lens driver for receiving a lens driver control signal from an image signal processor and driving a liquid-filled lens, comprising an input/output interface unit exchanging the lens driver control signal and the status information of the liquid-filled lens with the image signal processor according to a certain signal transmission protocol; a system clock generation unit for generating a system clock; a high voltage generation unit for generating high voltage, which can drive the liquid-filled lens, using low voltage of a battery of a mobile information terminal; a reference/bias voltage generation unit for providing reference voltage and bias voltage for operating the liquid-filled lens driver; a drive signal generation unit for generating a final drive signal fir the liquid-filled lens by boosting an output waveform to a high voltage level generated by the high voltage generation unit after generating the output waveform for driving the liquid-filled lens; and a control unit for controlling the function units for driving the liquid-filled lens.

According to another aspect of the present invention, there is provided a high voltage generation circuit for generating high voltage to drive a liquid-filled lens comprising a converter module for DC-converting voltage of a battery of a mobile information terminal into high voltage for driving the liquid-filled lens; a voltage conversion clock generation module for generating a voltage conversion clock that is used for the DC voltage conversion in the converter module; a voltage conversion arresting module for stopping voltage conversion by stopping operation of the converter module when the voltage conversion is performed such that the high voltage generated by the converter module exceeds voltage for driving the liquid-filled lens (reference voltage); a voltage division module for generating divided voltage lower than the high voltage by dividing the high voltage, which has been converted in the converter module, at a certain ratio; and a voltage comparison module for comparing curvature reference voltage required for operation of the liquid-filled lens with the divided voltage generated in the voltage division module, and providing an arresting signal to the voltage conversion arresting module when the divided voltage exceeds the curvature reference voltage. The voltage conversion clock generation module generates a plurality of clocks having various frequencies so that the converter module can selectively use a necessary voltage conversion clock. The converter module variably selects and uses the plurality of clocks, which are generated from the voltage conversion clocks, according to characteristics of electric elements (such as an inductor, a capacitor and a diode) of the corresponding converter module.

According to a further aspect of the present invention, there is provided a drive signal generation circuit for generating an output waveform to drive a liquid-filled lens, comprising: a drive signal clock generation module for generating a drive clock in a waveform period of a signal for driving the liquid-filled lens; a low voltage differential signal generation module for generating two low voltage differential signals having a voltage level of a battery of a mobile information terminal based on the drive clock; and a high voltage differential signal generation module for generating plus and minus differential drive signals, which is the final drive signal for the liquid-filled lens, by increasing a voltage amplitude of the low voltage differential signal to a level of the high voltage generated in the high voltage generation unit.

### DESCRIPTION OF DRAWINGS

The above and other objects, features and advantages of the present invention will be more clearly understood from the following detailed description taken in conjunction with the accompanying drawings, in which:

FIG. 1(a) is a diagram showing an internal construction of a liquid-filled lens;

FIG. 1(b) is a graph showing a curvature slope versus voltage applied to the liquid-filled lens;

FIG. 2 is a graph showing a differential signal for driving the liquid-filled lens according to the present invention;

FIG. 3 is a block diagram showing the operation of the liquid-filled lens;

FIG. 4 is a block diagram showing the internal construction of a liquid-filled lens driver according to the present invention;

FIG. 5 is a diagram showing voltage conversion clocks generated in a voltage conversion clock generation module;

FIG. 6 is a diagram showing an internal construction of a DC-to-DC converter stage;

FIG. 7 is a diagram showing an internal construction of an overcurrent detection stage;

FIG. 8 is a timing chart showing the signals of the liquid-filled lens driver; and

FIG. 9 is a diagram showing an internal construction of a high voltage differential signal generation module.

### BEST MODE

A preferred embodiment of the present invention is described in detail with reference to the attached drawings.

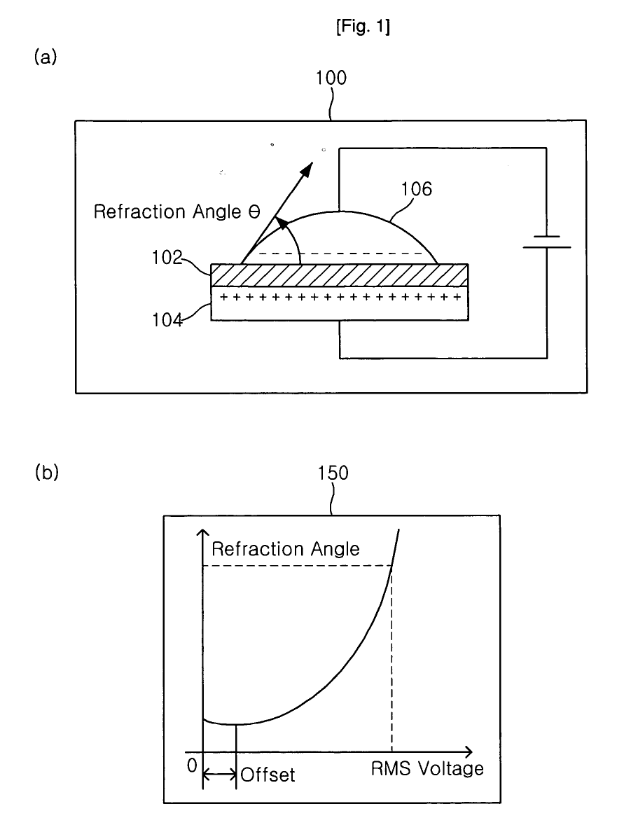

FIG. 1(a) is a diagram showing a liquid-filled lens and the application of a drive voltage, and FIG. 1(b) is a graph showing a refractive index of a liquid-filled lens versus voltage applied to the liquid-filled lens.

The liquid-filled lens, as shown in FIG. 1(a), is constructed in such a way that an insulator 102 is placed on a bottom electrode 104, a special liquid substance 106 is placed on the insulator 102, and electrodes are connected to two terminals of the liquid-filled lens. When voltage is applied to the liquid-filled lens, the refraction occurs in the liquid-filled lens according to the applied voltage. In regard to the electrode connection, one of the two terminals of the liquid-filled lens is connected to a ground GND, and the other terminal is connected to the electrode, so that the refractive index of the liquid-filled lens can vary.

In regard to the refractive index of light corresponding to the voltage, the variation in the refractive index of light passing through a lens occurs according to voltage, as shown in FIG. 1(b) (referring to U.S. Pat. No. 5,774,273). Accordingly, a desired variation in the focal distance of a lens can be generated by varying the refractive index of the lens using appropriate voltage based on the relationship between voltage and a refractive index.

Meanwhile, voltage used to drive the liquid-filled lens is higher than that of a battery used in a mobile information terminal to which the present invention is mainly applied. Accordingly, in the present invention, the voltage of the battery of the mobile information terminal is converted into relatively high voltage to drive the liquid-filled lens using the relatively low voltage generated in the battery of the mobile information terminal, and the liquid-filled lens is driven by a differential type liquid-filled lens drive signal.

The voltage conversion is performed in a drive signal generation unit 460 shown in FIG. 4, a detailed description of which will be described with reference to FIG. 4.

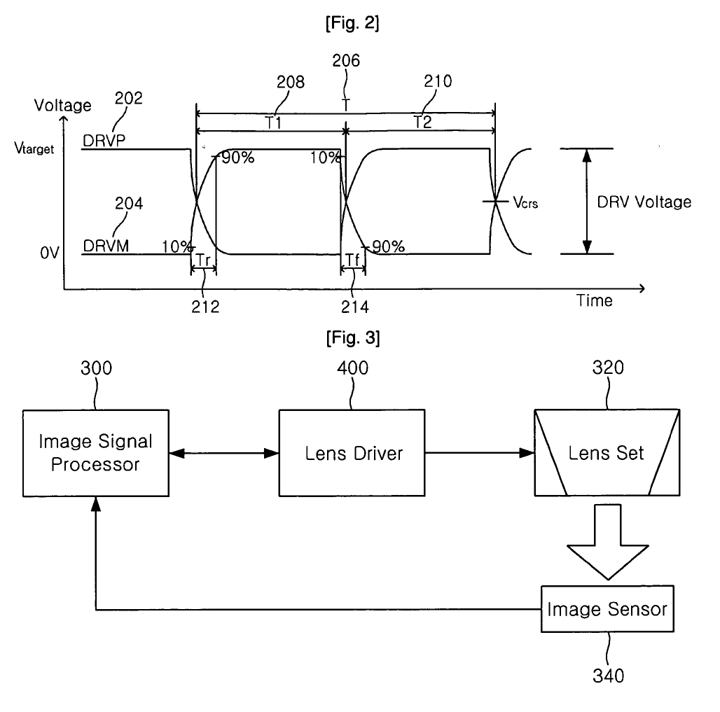

The differential type drive signal shown in FIG. 2 is generated by a drive signal generation unit 40 shown in FIG. 4. Root Mean Square (RMS) voltage applied between the two electrodes of the liquid-filled lens can be increased using the differential type drive signal.

In a prior art, one of the two terminals of the lens is connected to a ground GND and the other terminal is connected to the electrode of the lens. In contrast, in the present invention, the lens is driven using a minus drive signal DRVM 204 and a plus drive signal DRVP 202, thus obtaining relatively high RMS voltage.

That is, high RMS voltage can be obtained by applying the minus drive signal 204 and the plus drive signal 202 to the two terminals of the lens, respectively, compared with a case where a single differential signal is used. As a result, a high voltage drive signal sufficient to drive the liquid-filled lens can be output using the low voltage of a mobile information terminal.

In the meantime, the rising time Tr 212 and falling time Tf 214 for 10-90% of a different signal waveform are selected by the characteristics of the liquid-filled lens, and the signal period T 206 and half-periods T1 and T2 208 and 210 are also determined by the characteristics of the liquid-filled lens. Accordingly, the waveform of the differential signal must be designed to have certain slopes Tr and Tf in consideration of Electro Magnetic Interference (EMI) noise caused by the voltage of the liquid-filled lens drive signal and the response characteristics of the refractive index with respect to the voltage variation of the liquid-filled lens.

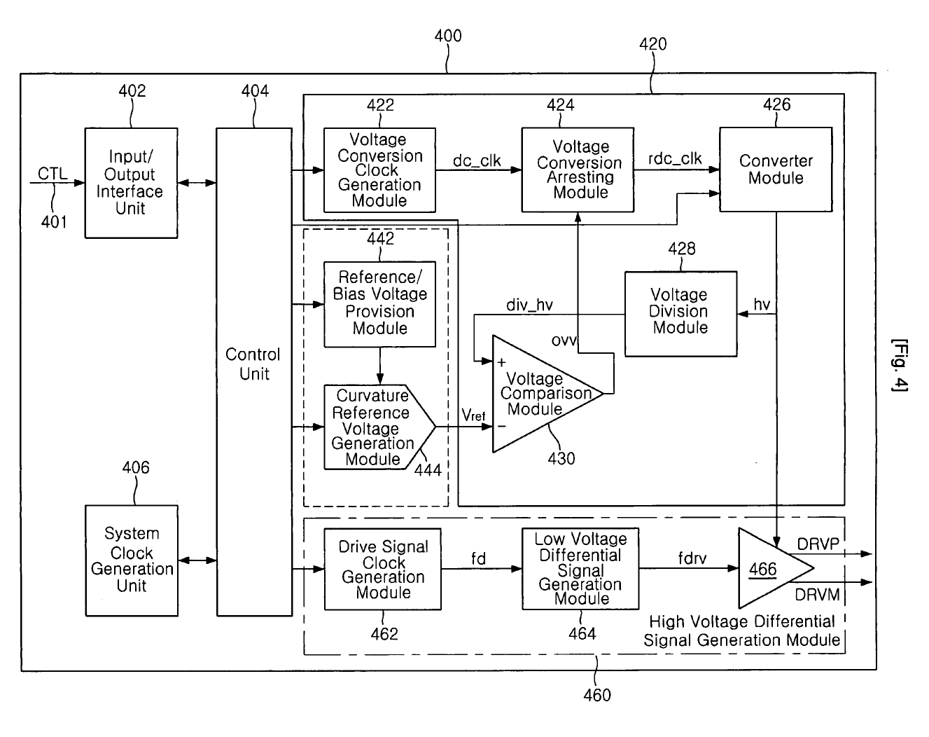

FIG. 3 is a block diagram showing the connection between a lens set, an image sensor, an image signal processor and a liquid-filled lens driver of the present invention.

The image signal processor 300 generates a lens driver control signal CTL based on the characteristics of an image input from the lens set 320 through the image sensor 340.

The lens set 320 is a combination of a conventional optical lens and the liquid-filled lens. Generally, in the case of supporting an auto focusing or auto macro function, a lens set firmed by combining general optical lenses made of glass or plastic with a liquid-filled lens is used. In the case of a lens set having an auto Dooming function, conventional optical lenses and two or more liquid-filled lenses may be used.

In a case where a plurality of liquid-filled lenses exist in a lens set as described above, liquid-filled lens drivers 400 exist to control the liquid-filled lenses and are each assigned a unique ID, so that the image signal processor 300 selects a desired one of the liquid-filled lens drivers and transmits a lens driver control signal.

In brief the liquid-filled lens drivers 400 are drivers that drive a plurality of liquid-filled lenses in the lens set 320, respectively. Each of the liquid-filled lens drivers 400 receives the lens driver control signal CTL from the image signal processor, generates a differential signal for driving the liquid-filled lens, and outputs the differential signal as shown in FIG. 2.

Meanwhile, although in FIG. 3, the liquid-filled lens drivers 400 are illustrated as a single block, a plurality of the liquid-filled lens drivers assigned to a plurality of liquid-filled lenses may exist when the plurality of liquid-filled lenses exists in the lens set.

FIG. 4 is a block diagram showing an internal construction of the liquid-filled lens driver shown in FIG. 3.

The liquid-filled lens driver includes an input/output interface unit 402, a control unit 404, a system clock generation unit 406, a high voltage generation unit 420, a reference/bias voltage generation unit 440, and a drive signal generation unit 460.

The input/output interface unit 402 functions as a signal transmission/reception interface with the image signal processor ISP 300 using serial/parallel communication method or some other signal transmission method. The input/output interface unit 402 decodes the lens driver control signal CTL received from the image signal processor 300, and transmits the status of the liquid-filled lens to the image signal processor according to a signal transmission protocol. Furthermore, the input/output interface unit 402 receives status information, such as the curvature of the liquid-filled lens and the operational status of a power source, from the control 404, and transmits the status information to the image signal processor ISP 300.

For the above-described work, the input/output interface unit is composed of at least two or three wires 401 to interface with the image signal processor.

In the case of a 2-wire serial communication method one signal wire is a clock signal wire related to clocks, and the other wire is a data signal wire related to liquid-filled lens-related data. In this case, the data signal wire functions as an interface for a power control signal as well as the liquid-filled lens-related data.

A 3-wire serial communication method may be constructed by adding a power control line to control the power source of the liquid-filled lens driver, in addition to the clock signal wire and the data signal wire.

In a case where a lens driver control signal structure is constructed using three wires, one wire is a clock signal wire related to a clock, another wire is a data signal wire related to data and the other wire is a power control line that selects between power down mode and normal operation mode.

Through the clock and data signal wires, commands for performing various control and data fir adjusting the curvature of the lens are received and information about internal status is transmitted. That is, the input/output interface sets register values by writing or reading data at the addresses of internal registers, and the image signal processor can control the liquid-filled lens drivers or set voltage values for driving the liquid-filled lenses.

Power down mode or normal operation mode is assigned to the liquid-filled lens driver on the basis of the status of the power control signal wire. When a power down mode message is received from the power control signal wire, the liquid-filled lens driver disables all the bias voltage of the liquid-filled lens driver to minimize the power consumption of the liquid-filled lens driver, and stops the operation of the high voltage generation unit and the drive signal generation unit by stopping the operation of an internal clock generator.

Meanwhile, when an auto Doming function needs to be implemented it is necessary to mount a plurality of liquid-filled lenses in a mobile information terminal and operate the lenses. In this case, liquid-filled lens drivers must be provided in the liquid-filled lenses to drive the liquid-filled lenses.

A unique ID is assigned to each of the liquid-filled lens drivers so that the image signal processor ISP 300 can identify a plurality of the liquid-filled lens drivers and transmit control and data signals. Accordingly, the image signal processor can selectively use the liquid-filled lens drivers by also transmitting the unique ID of a specific liquid-filled lens driver when the control signal is transmitted to the corresponding liquid-filled lens driver using the clock and data signal wires.

Meanwhile, although in the above description, the input/out interface unit has been described as receiving the lens driver control signal and the like from the image signal processor ISP 300, it is not necessarily required to receive the lens driver control signal and the like from the image signal processor ISP so as to embody the present invention. That is, the present invention may be constructed to provide the control signal by additionally providing a liquid-filled lens driver control signal generator for providing the liquid-filled lens driver control signals, instead of the image signal processor ISP. Accordingly, it should be appreciated that in the below-described detailed description and the claims, the image signal processor refers to not only the conventional image signal process but also the liquid-filled lens driver control signal generator that provides the control signals for driving the liquid-filled lens drivers.

The control unit 404 generates signals, which control the high voltage generation unit 420, the reference/bias voltage generation unit 440, and the drive signal generation unit 460, using signals received form the input/output interface unit.

The system clock generation unit 406 is a precision frequency oscillator. Since a crystal oscillator cannot be employed due to the spatial limitation in the circuit construction of a system to which the present invention is applied an R-C type oscillator that can be easily mounted in a semiconductor chip is employed as the system clock generation unit 406.

The high voltage generation unit 420 comprises a voltage conversion clock generation module, a voltage conversion arresting module, a converter module, a voltage division module, a voltage comparison module and the like. The high voltage generation unit 420 functions to generate high voltage, which is required fir driving the liquid-filled lens, using the voltage of the battery of the mobile information terminal.

The battery of the mobile information terminal generally supplies voltage less than 5V, while the voltage required for driving the liquid-filled lens is generally 40˜60 V. Accordingly, the high voltage generation unit 420 converts the relatively low voltage of the mobile information terminal into relatively high voltage required for driving the liquid-filled lens.

The converter module 426 functions as a DC-to-DC converter that converts low DC voltage into high DC voltage, in particular, a boost-up DC-to-DC converter that boosts the low voltage of the battery to high voltage required for driving the liquid-filled lens.

The converter module 426, as shown in FIG. 6, includes a DC-to-DC converter stage 610, an overcurrent detection stage 601, and an AND gate 602, detailed descriptions of which will be described later with reference to FIG. 6. Here, the characteristics of the DC-to-DC converter stage 610, which is the core of the converter module 426, will be described below.

The amount of current consumed to drive the liquid-filled lens is so small as to be used to charge or discharge the capacitor component (generally, several hundreds pF) of the liquid-filled lens. Accordingly, the DC-to-DC converter stage 610 is firmed in a discontinuous current mode DC-to-DC converter.

The discontinuous current mode DC-to-DC converter is a DC converter in which the moment when the current thereof becomes zero exists at the moment when DC-to-DC conversion occurs, contrary to a general continuous current mode DC-to-DC converter in which the current flowing through the inductor 604 shown in FIG. 6 is continuous. Since the discontinuous current mode DC-to-DC converter is well known to those skilled in the art, a detailed description thereof is omitted here.

In general, the discontinuous current mode DC-to-DC converter used in the present invention is not used in a boost-up type DC-to-DC converter (which converts low voltage into high voltage), but is used in a buck type DC-to-DC converter (which converts high voltage into low voltage).

The reason why the discontinuous current mode DC-to-DC converter is employed in the present invention is because the voltage into which the voltage of the battery of the mobile information terminal is converted is considerably higher than that of the battery, the power consumption of the liquid-filled lens is significantly small, and higher frequency DC conversion clock needs to be used to employ a small volume inductor since the present invention is mainly applied to small-sized products such as a mobile phone and a digital camera.

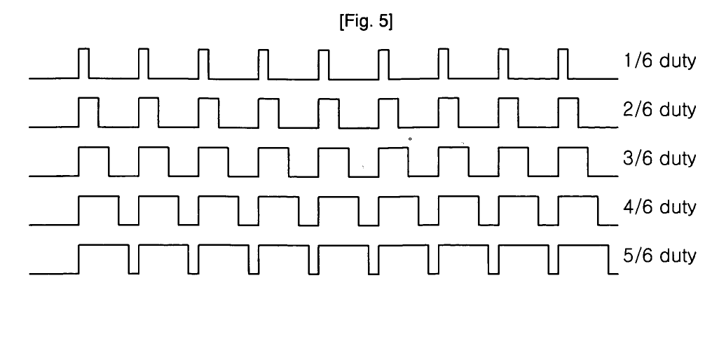

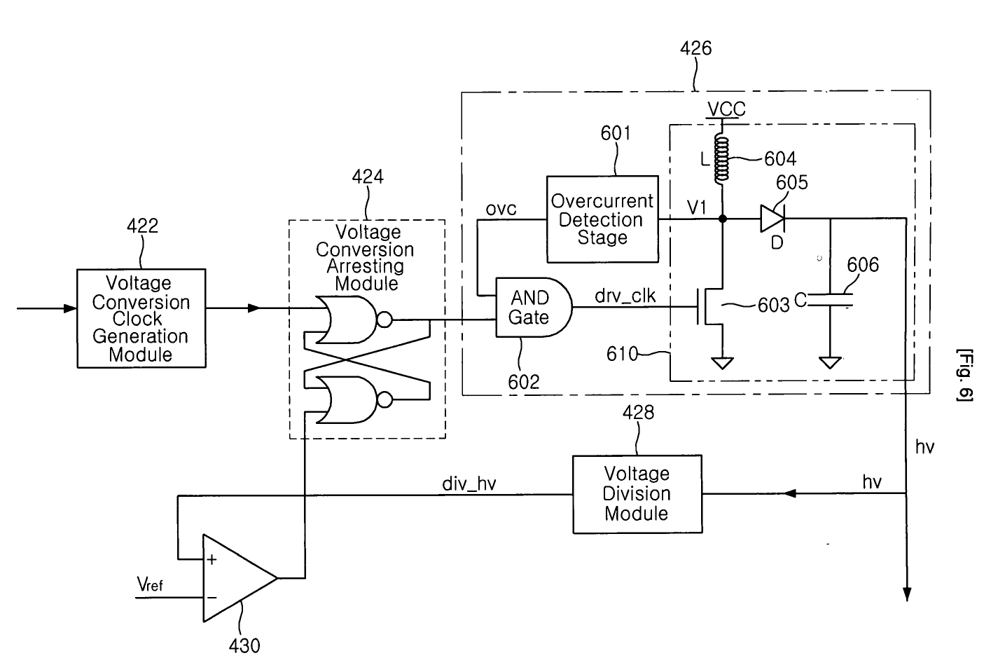

The voltage conversion clock generation module 422 is a circuit that generates voltage conversion clocks dc_clk used in the converter module 426. The generated voltage conversion clocks are shown in FIG. 5. The reason why the voltage conversion clock generation module generates various clocks as shown in FIG. 5 is to use one of the generated clocks that is necessary for the DC converter.

That is, generally, when constructing the DC-to-DC converter stage, the tuning of the values of an inductor L, a capacitor C and a diode D is performed after design of the converter is completed. In contrast, since the mobile information terminal to which the present invention is applied is small, the converter stage should be embodied after usable elements, such as an inductor, a capacitor and a diode, are previously determined. Accordingly, clocks are selected and used after the various clocks are generated as shown in FIG. 5 so that elements, such as an inductor, a capacitor and a diode, the specifications of which are previously determined are controlled to conform to the characteristics of the elements.

The voltage conversion arresting module 424 regards the voltage generated in the converter module 426 to reach a desired voltage when the voltage generated in the converter module is higher than the curvature reference voltage Vref generated in the reference/bias voltage generation unit 440, and thus functions to stop the voltage conversion.

The voltage division module 428 attenuates the voltage generated in the converter module 426 at a uniform rate and, thereafter, transmits divided voltage div_hv, which is a comparison target signal, to the voltage comparison module.

The voltage comparison module 430 compares a curvature reference voltage Vref from the reference/bias voltage generation unit 440 with the divided voltage div_hv from the voltage division module, and transmits an arresting signal to the voltage conversion arresting module 426 when the divided voltage div_hv is higher than the curvature reference voltage Vref. Thus, the voltage conversion arresting module 424 can stop the voltage conversion operation of the converter module 426.

The reference/bias voltage provision module 442 functions to supply constant voltage to the curvature reference voltage generation module, and further supply bias voltage and reference voltage to other peripheral circuits.

The curvature reference voltage generation module 444, which is a Digital-to-Analog converter, functions to generate analog voltage corresponding to the curvature value of the liquid-filled lens transmitted from the image signal processor, and output the curvature reference voltage Vref to the voltage comparison module.

The drive signal generation unit 460 is a function unit that outputs a drive signal for driving the liquid-filled lens, and functions to finally output a drive signal to be transmitted to the liquid-filled lens.

The drive signal generation unit 460 includes a drive signal clock generation module 462, a low voltage differential signal generation module 464, and a high voltage differential signal generation module. The drive signal clock generation module 462 is a part for generating the period T of a differential signal, and generates a frequency component 1/T. The frequency generated in that case also outputs drive signal clocks ranging from several hundreds Hz to several tens KHz to select an optimal drive frequency according to the purpose and electrostatic characteristics of the liquid-filled lens, as described in conjunction with the voltage conversion clock generation module 422. The output drive signal clock is generated by the system clock input from the system clock generation unit 406 and the signal controlled from the control unit 404.

The low voltage differential signal generation module 464 outputs a differential signal having low voltage corresponding to the level of the battery voltage of the mobile information terminal. The differential signal is output in differential firm to increase RMS voltage that is applied between the two electrodes of the liquid-filled lens.

Relatively high RMS voltage can be achieved by driving the two electrodes of the liquid-filled lens using differential signals DRVP and DRVM, rather than grounding one of the two terminals of the liquid-filled lens and applying a drive signal to the other terminal according to the conventional method.

That is, the high RMS voltage can be achieved by applying the minus drive signal DRVM and the plus drive signal DRVP to the two terminals of the liquid-filled lens rather than using a single differential signal, so that a high voltage drive signal sufficient to drive the liquid-filled lens can be output using the low voltage of the mobile information terminal.

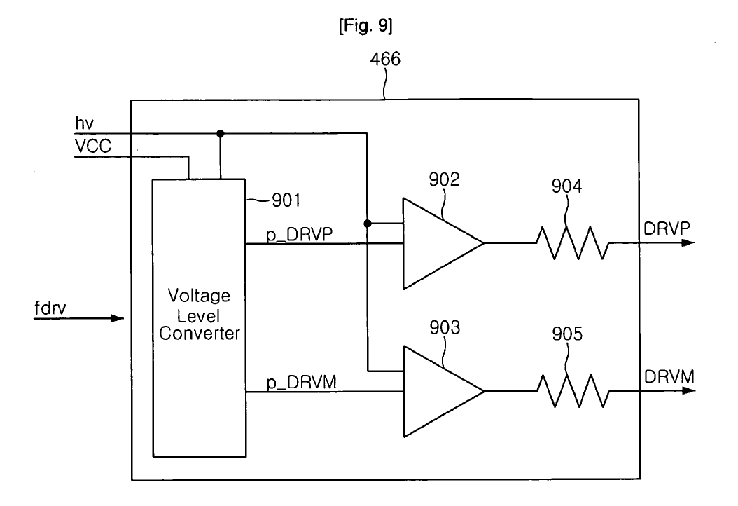

The high voltage differential signal generation module 466 is a block that generates an actual drive signal driving the liquid-filled lens. The high voltage differential signal generation module 466 functions to amplify a low voltage differential signal fdrv, which is output from the low voltage differential signal generation module 464, to the level of the voltage output from the DC-to-DC converter. The construction of the high voltage differential signal generation module 466 is illustrated in detail in FIG. 9.

FIG. 6 is a block diagram showing the converter module 426 of FIG. 4 in detail.

The converter module 426 includes the DC-to-DC converter stage 610, the overcurrent detection stage 601, and the AND gate 602. The DC-to-DC converter stage is a discontinuous DC-to-DC converter, which was described above.

The overcurrent detection stage 601 protects an inductor 604 and a first transistor 603 from overcurrent and increases the efficiency of voltage conversion by limiting the amount of current flowing through the inductor 604 and the first transistor 603.

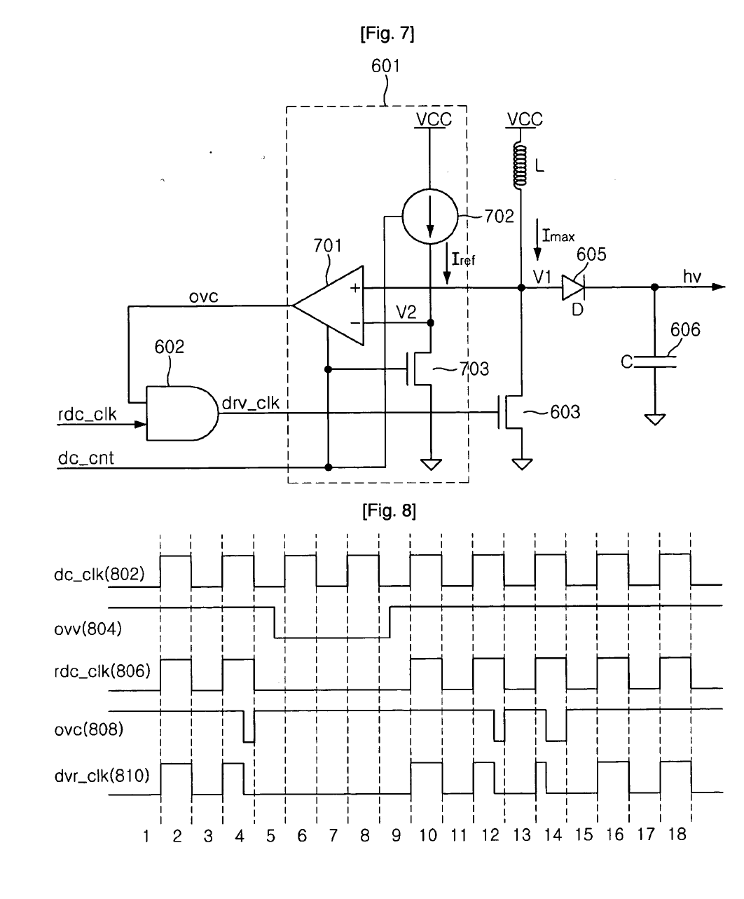

The first transistor 603 refers to the whole of semiconductor switching elements having a function of making current on/off on a semiconductor, such as a MOSFET, a BJT, a JEFF and a BiCMOS transistor. Similarly, a second transistor 703 shown in FIG. 7 corresponds to a concept that includes semiconductors performing a switching function. Accordingly, in the present invention, it is apparent that the first and second transistors 603 and 703 correspond to a concept including semiconductor switching elements having a function of making current on/off on a semiconductor, such as a MOSFET, a BJT, a JEFT and a BiCMOS transistor. However, for ease of illustration, the first and second transistors 603 and 703 are represented by MOSFET in FIGS. 6 and 7.

Meanwhile, overcurrent flowing through the inductor 604 and the first transistor 603 degrade the inductor 634 and the first transistor 603, thus reducing the voltage conversion efficiency and, in the worst case, breaking the inductor 604 and the first transistor 603. Accordingly, the overcurrent detection stage 601 generates an overcurrent detection signal ovc that allows overcurrent to be detected and cut off when the overcurrent flows.

The generated overcurrent detection signal ovc is transmitted to the AND gate 602.

Then, the AND gate 602 causes a first transistor drive clock drv_clk for driving the first transistor to be ‘L’ when the overcurrent detection signal is ‘L,’ thus maintaining the first transistor at an OFF state. In contrast, when the overcurrent detection signal is ‘H,’ a level signal identical to a voltage conversion real clock rdc_clk is transmitted as the first transistor drive clock drv_clk, thus allowing the converter module to normally operate.

The detailed circuit construction of the overcurrent detection stage 601 is illustrated in FIG. 7.

In order to increase the efficiency of voltage conversion and generate high voltage, overcurrent is detected using the second transistor 703, a constant current source 702, and the overcurrent detection voltage comparator 701. A process of detecting overcurrent will be described as follows.

After the amount of maximum current Imax, which can flow through the inductor 604 or first transistor 603, is calculated the second transistor smaller than the first transistor by the first transistor divided by N (wherein N is an integer) is selected. Furthermore, control is performed to allow constant current Iref to flow by designing the constant current source 702 having a current capacity of Imax/N (wherein N is an integer).

When a semiconductor Integrated Circuit (IC) is designed, the error rate of a circuit process can be reduced only, when design is performed in such a way that the channel lengths of the first and second transistors M1 603 and M2 703 are identical and the channel width of the first transistor M1 603 is N times larger than that of the second transistor M2 703, or in such a way that the number of transistors having the same channel width and the same channel length is as many as N.

In regard to a resistance value (hereinafter referred to as an ‘ON resistance value’) existing when the first and second transistors 603 and 703 designed as described above are turned on, when the ON resistance value of the first transistor 603 is R, the second transistor has a value of R*N (wherein N is an integer). Accordingly, the voltage difference between the voltage V1, which is generated when the current Imax flows through the first transistor, and the voltage V2, which is generated when the current Iref flows through the second transistor, is theoretically O(zero)V.

In that case, the case where V1 is higher than V2 corresponds to the case where overcurrent flows through the inductor 604 and the first transistor 603. The overcurrent detection voltage comparator 701 using V1 and V2 as input signals changes the overcurrent detection signal ovc from ‘H (High)’ to ‘L (Low)’ as shown in FIG. 8. In contrast, the case where V1 is lower than V2 does not correspond to the case where current flowing through the inductor 604 and the first transistor 603 is in an overcurrent state, so that the overcurrent detection signal ovc of the overcurrent detection voltage comparator 701 is maintained at ‘H.’

Meanwhile, when the overcurrent detection circuit is constructed it is important to design the reference constant current source so that the current capacity of the reference constant current source can be variably set to coincide with the consumed current and drive voltage of various liquid-filled lenses. The setting is performed through an overcurrent detection control signal dc_cnt. Furthermore, the overcurrent detection voltage comparator is controlled through the overcurrent detection control signal dc_cnt so that comparison operation should be performed only while the first and second transistors operate.

FIG. 8 is a timing chart fir the signals shown in FIG. 6.

A voltage conversion clock dc_clk 802 is a signal output from the voltage conversion clock generation module, and an arresting signal ovv 804 is a signal output from the voltage comparison module. When the divided voltage div_hv of the high voltage generated by the converter module is lower than the reference voltage Vref, the arresting signal ovv of ‘H’ is generated and output to the arresting module; while when the divided voltage div_hv is higher than the reference voltage Vref, the arresting signal ovv of ‘L’ is generated and output to the arresting module.

The arresting signal ovv 804 generates a voltage conversion real clock rdc_clk 806. In this case, when the voltage of the converter module 426 does not reach desired voltage, the clocks are continuously generated, thus maintaining the voltage conversion; while when the voltage of the converter module 426 reaches desired voltage, the generation of the clocks is stopped, thus stopping the DC conversion.

In the meantime, when overcurrent flows through the inductor 604 and the first transistor 603, the overcurrent detection voltage comparator 701 detects the overcurrent and outputs an overcurrent detection signal ovc 808 of ‘L’, and the AND gate 602 performs logical AND operation on the overcurrent detection signal ovc 808 and the voltage conversion real clock rdc_clk 806, processes the voltage conversion real clock rdc_clk 806 to ‘L,’ and thus, generates a first transistor drive clock, thus turning off the first transistor, and thus, preventing the circuit from being damaged by the overcurrent.

FIG. 9 is a detailed circuit of the high voltage differential signal generation module shown in FIG. 4, in which the high voltage differential signal generation module is an actual drive module that drives the liquid-filled lens.

A voltage level converter 901 functions to convert the low voltage drive signal fdrv, which is generated by the low voltage differential signal generation module, from the voltage level of the battery of the mobile information terminal into the voltage level of the high voltage hv input from the converter module.

A first drive buffer 902 and a second drive buffer 9(3 are designed so that they have capacity larger than capacity required f[r driving the liquid-filled lens, thus approaching ideal buffers.

The amount of current and driving capability required for driving the liquid-filled lens are adjusted using a first resistor 904 and a second register 905. The first and second resistors 904 and 905 are used as slop adjusting resistors that function to keep the rising and falling times Tr and Tf of the differential signal of FIG. 2 uniform regardless of the amplitude of the signal that is used to drive the liquid-filled lens.

The plus drive signal DRVP and the minus drive signal DRVM generated by the first drive buffer 902 and the first resistor 904 and the second drive buffer 903 and the second resistor 905 can be opposite in phase and identical in shape, as shown in FIG. 2, regardless of the deviation in the semiconductor manufacturing process of driver buffers and resistors and the variation in high voltage hv.

As a result, the liquid-filled lens drive signal generated through the above-described process generates a relatively low amount of EMI noise, and can effectively drive the liquid-filled lens using a relatively low amount of current.

### INDUSTRIAL APPLICABILITY

As described above, according to the present invention, a voltage level capable of driving the liquid-filled lens can be generated using low voltage, such as the voltage of the battery of a mobile information terminal, so that the liquid-filled lens driver can be implemented in a single chip that can be simply mounted in the mobile information terminal. Furthermore, relatively high RMS drive voltage is generated by applying the liquid-filled lens drive signal in differential form, so that the efficiency of voltage provided can be increased.

Although the preferred embodiment of the present invention has been disclosed for illustrative purposes, those stilled in the art will appreciate that various modifications, additions and substitutions are possible, without departing from the scope and spirit of the invention as disclosed in the accompanying claims.

1-23. (canceled)

24. A liquid-filled lens driver for receiving a lens driver control signal from an image signal processor and driving a liquid-filled lens, comprising:
an input/output interface unit exchanging the lens driver control signal and status information of the liquid-filled lens with the image signal processor according to a certain signal transmission protocol;
a system clock generation unit for generating a system clock;
a high voltage generation unit for generating high voltage, which can drive the liquid-filled lens, using low voltage of a battery of a mobile information terminal;
a voltage generation unit for providing reference voltage and bias voltage for operating the liquid-filled lens driver;
a drive signal generation unit for generating a final drive signal for the liquid-filled lens by generating an output waveform for driving the liquid-filled lens and boosting the output waveform to a high voltage level generated by the high voltage generation unit; and
a control unit for controlling the function units so that they can drive the liquid-filled lens.

25. The liquid-filled lens driver according to claim 24, wherein the liquid-filled lens driver is provided to each of liquid-filled lens, and is provided with a unique Identification (ID).

26. The liquid-filled lens driver according to claim 24, wherein the exchanging of the lens driver control signal and the status information of the liquid-filled lens by the input/output interface unit is performed by a 2-wire serial communication method using:
a clock signal wire for exchanging a control clock signal that controls the exchanging of image information; and
a data signal wire for exchanging data related to the image information and determining power status of the liquid filled lens driver.

27. The liquid-filled lens driver according to claim 26, wherein the determination of the power status of the liquid-filled lens driver is performed in such a way as to stop operation of the liquid-filled lens driver by disabling all reference voltage and bias voltage of the liquid-filled lens driver and turning off the system clock generation unit when a power-off mode signal is received.

28. The liquid-filled lens driver according to claim 26, wherein the determination of the power status of the liquid-filled lens driver is performed in such a way as to normally operate the liquid-filled lens driver by enabling all reference voltage and bias voltage of the liquid-filled lens driver and turning on the system clock generation unit when a normal power mode signal is received.

29. The liquid-filled lens driver according to claim 24, wherein the exchanging of the lens driver control signal and the status information of the liquid-filled lens by the input/output interface unit is performed by a 3-wire serial communication method using:
a clock signal wire for exchanging a control clock signal that controls the exchanging of image information;
a data signal wire for exchanging data related to the image information; and
a power control signal wire for determining power status of the liquid-filled lens driver.

30. The liquid-filled lens driver according to claim 29, wherein the determination of the power status of the liquid-filled lens driver is performed in such a way as to stop operation of the liquid-filled lens driver by disabling all reference voltage and bias voltage of the liquid-filled lens driver and turning off the system clock generation unit when a power-off mode signal is received.

31. The liquid-filled lens driver according to claim 29, wherein the determination of the power status of the liquid-filled lens driver is performed in such a way as to normally operate the liquid-filled lens driver by enabling all reference voltage and bias voltage of the liquid-filled lens driver and turning on the system clock generation unit when a normal power mode signal is received.

32. The liquid-filled lens driver according to claim 24, wherein the exchanging of the lens driver control signal and the status information of the liquid-filled lens by the input/output interface unit is performed in such a way as to receive an effective data signal through a data signal wire by synchronizing with a clock signal transmitted through a clock signal wire.

33. The liquid-filled lens driver according to claim 24, wherein the exchanging of the lens driver control signal and the status information of the liquid-filled lens by the input/output interface unit is performed in such a way as to set a register value in the input/output interface and read/write information from/in the register.

35. The liquid-filled lens driver according to claim 24, wherein the exchanging of the lens driver control signal and the status information of the liquid-filled lens by the input/output interface unit is performed while controlling each liquid-filled lens driver using a unique ID of the liquid-filled lens driver.

36. The liquid-filled lens driver according to claim 24, wherein the high voltage generation unit comprises:
a converter module for Direct Current (DC) converting voltage of a battery of the mobile information terminal into high voltage for driving the liquid-filled lens;
a voltage conversion clock generation module for generating a voltage conversion clock that is used for the DC voltage conversion by the converter module; and
a voltage conversion arresting module for stopping voltage conversion by stopping operation of the converter module when the voltage conversion is performed such that the high voltage generated by the converter module exceeds voltage for driving the liquid-filled lens (reference voltage).

36. The liquid-filled lens driver according to claim 35, wherein the high voltage generation unit further comprises:
a voltage division module for generating divided voltage lower than the high voltage by dividing the high voltage, which has been obtained through the conversion by the converter module, at a certain ratio; and
a voltage comparison module for comparing curvature reference voltage required for operation of the liquid-filled lens with the divided voltage generated by the voltage division module, and providing an arresting signal to the voltage conversion arresting module when the divided voltage exceeds the curvature reference voltage.

37. The liquid-filled lens driver according to claim 24, wherein the reference/bias voltage generation unit comprises:
a reference/bias voltage provision module for providing reference and bias voltage to electronic elements of the liquid-filled lens driver; and
a reference voltage generation module for generating analog voltage corresponding to a curvature value (drive voltage) of the liquid-filled lens transmitted from the image signal processor.

38. The liquid-filled lens driver according to claim 24, wherein the drive signal generation unit comprises:
a drive signal clock generation module for generating a drive clock in a waveform period of a signal for driving the liquid-filled lens;
a low voltage differential signal generation module for generating two low voltage differential signals having a voltage level of a battery of the mobile information terminal based on the drive clock; and
a high voltage differential signal generation module for generating plus and minus differential drive signals, that is, the final drive signal for the liquid-filled lens, by increasing a voltage amplitude of the low voltage differential signal to a level of the high voltage generated by the high voltage generation unit.

39. The liquid-filled lens driver according to claim 24, wherein the input/output interface unit, the system clock generation unit, the high voltage generation unit, the reference/bias voltage generation unit, the drive signal generation unit, and the control unit are integrated in a single chip.

40. A high voltage generation circuit for generating high voltage to drive a liquid-filled lens, comprising:
a converter module for DC-converting voltage of a battery of the mobile information terminal into high voltage for driving the liquid-filled lens;
a voltage conversion clock generation module for generating a voltage conversion clock that is used for the DC voltage conversion by the converter module;
a voltage conversion arresting module for stopping voltage conversion by stopping operation of the converter module when the voltage conversion is performed such that the high voltage generated by the converter module exceeds voltage for driving the liquid-filled lens (reference voltage);
a voltage division module for generating divided voltage lower than the high voltage by dividing the high voltage, which has been obtained through the conversion by the converter module, at a certain ratio; and
a voltage comparison module for comparing curvature reference voltage required for operation of the liquid-filled lens with the divided voltage generated by the voltage division module, and providing an arresting signal to the voltage conversion arresting module when the divided voltage exceeds the curvature reference voltage;
wherein the voltage conversion clock generation module generates a plurality of clocks having various frequencies so that the converter module can selectively use a voltage conversion clock; and
wherein the converter module variably selects and uses the plurality of clocks, which are generated from the voltage conversion clocks, according to characteristics of electric elements (inductor, capacitor, diode) of the converter module.

41. The high voltage generation circuit according to claim 40, wherein the converter module comprises:
a discontinuous current mode DC-to-DC converter stage for causing current flowing through an inductor to be discontinuous;
an overcurrent detection stage for detecting overcurrent and generating an overcurrent detection signal when the overcurrent flows through the inductor and a first transistor for performing voltage amplification conversion; and
an AND gate for generating a first transistor drive clock, that is, a bias voltage signal to the first transistor, by performing logical AND operation on the overcurrent detection signal received from the overcurrent detection stage and the voltage conversion clock generated by the voltage conversion clock generation module.

42. The high voltage generation circuit according to claim 41, wherein the overcurrent detection stage comprises:
a second transistor having a capacity corresponding to 1/N (N is an integer) of that of the first transistor;
a constant current source for calculating allowable maximum current capable of flowing through the inductor and the first transistor of the DC-to-DC converter stage, and applying constant current corresponding to a value (that is, allowable maximum current/N) obtained by dividing the allowable maximum current by N; and
an overcurrent detection voltage comparator for comparing amplification voltage V1, which is generated when the first transistor of the DC-to-DC converter operates, with amplification voltage V2 of the second transistor, which is generated when the constant current generated by the constant current source flows, and generating an overcurrent detection signal when the VI is higher than V2.

43. The high voltage generation circuit according to claim 42, wherein the constant current source receives the overcurrent detection signal for variably controlling an amount of current from the control unit, and applies constant current corresponding to the consumed current and drive current of the liquid-filled lens.

44. The high voltage generation circuit according to claim 42, wherein the excessive current detection voltage comparator receives a control signal, and performs comparison only when the first and second transistors operate.

45. A drive signal generation circuit for generating an output waveform to drive a liquid-filled lens, comprising:
a drive signal clock generation module for generating a drive clock in a waveform period of a signal for driving the liquid-filled lens;
a low voltage differential signal generation module for generating two low voltage differential signals having a voltage level of a battery of the mobile information terminal based on the drive clock; and
a high voltage differential signal generation module for generating plus and minus differential drive signals, that is, the final drive signal for the liquid-filled lens, by increasing a voltage amplitude of the low voltage differential signal to a level of the high voltage generated by the high voltage generation unit.

46. The drive signal generation circuit according to claim 45, wherein the drive signal clock generation module generates a plurality of clocks having various frequencies so that the low voltage differential signal generation module can selectively use an optimal differential signal period for driving the liquid-filled lens.

47. The drive signal generation circuit according to claim 45, wherein the liquid-filled lens is operated in a differential signal manner by connecting a first of plus and minus drive signals to a first terminal of the liquid-filled lens and a second of the plus and minus drive signals to a second terminal of the liquid-filled lens.

48. The drive signal generation circuit according to claim 45, wherein the high voltage differential signal generation module comprises:
a voltage level converter for generating plus and minus drive signals, that is, final drive signals, by voltage level-converting voltage of the low voltage drive signal generated in the low voltage differential signal generation module into high voltage input from a converter module;
first and second buffers for buffering the plus and minus drive signals, which are generated by the voltage level converter, with respect to the liquid-filled lens; and
a slope adjusting resistor for keeping slopes of rising and falling edges of the plus and minus drive signals uniform regardless of signal amplitude.
